(19) United States
(12) Patent Application Publication
(10) Pub. No.: US 2018/0260479 A1
(43) Pub. Date: Sep. 13, 2018

(54) METHOD, APPARATUS, SYSTEM AND ELECTRONIC DEVICE FOR PICTURE BOOK RECOGNITION

(71) Applicant: Beijing Ling Technology Co.,Ltd., Beijing (CN)

(72) Inventors: Xi WANG, Beijing (CN); Jiawei GU, Beijing (CN); Weixin WU, Beijing (CN); Le XU, Beijing (CN); Hai QING, Beijing (CN); Zhidong ZHU, Beijing (CN)

(73) Assignee: Beijing Ling Technology Co.,Ltd., Beijing (CN)

(21) Appl. No.: 15/913,570

(22) Filed: Mar. 6, 2018

(30) Foreign Application Priority Data
Mar. 9, 2017 (CN) 201710138012.4

(51) Int. Cl. G06F 17/30; G06K 9/62

(52) U.S. Cl. CPC G06F 17/30752; H04L 65/4069; G06F 17/30256; G06K 9/6202

(57) ABSTRACT

The present invention discloses a picture book recognition method applied to an apparatus with a camera, comprising: acquiring an image of the picture book with the camera at a preset acquisition frequency; uploading the image to a server; receiving a first audio link corresponding to the image returned from the server and, if the image is an image of a cover of the picture book, receiving a picture book ID corresponding to the cover image; and connecting to a first audio stream in the server and playing the audio according to the first audio link. The present invention further provides a picture book recognition apparatus, system and electronic device. The picture book recognition method, apparatus, system and electronic device provided by the present invention solve the problem of high error rate in picture book recognition in the prior art.

### CROSS-REFERENCES

The present application claims benefits and priority of Chinese Patent Application No. 201710138012.4, filed on Mar. 9, 2017.

### TECHNICAL FIELD

The present invention relates to the field of data processing technologies, and in particular, to a picture book recognition method, apparatus, system and electronic device.

### BACKGROUND

A picture book is a type of book containing mainly pictures, with a small amount of text. Picture books can not only be used to tell stories, teach knowledge, but also to help children's mental education and development of intelligence.

Traditionally, there are two approaches for the recognition of picture books. One approach is the use of a reading pen, which scans the two-dimensional code information invisible to human eyes printed on a picture book through a photoelectrical recognizer contained in the pen tip. After the CPU in the pen processes and identifies the information, it picks out the corresponding audio stored in the memory of the pen and plays the audio by speaker. The other approach is the use of a reading machine, in which case an audio file is configured with “longitude and latitude” positions corresponding to contents of the picture book during preparation of the audio file. The user places the picture book on a platform of the reading machine and touches the texts, pictures numbers etc on the book with a special pen such that the reading machine plays a corresponding sound.

In addition to the traditional approaches described above, there is another approach in the prior art for picture book recognition through image recognition. However, in the field of image recognition in the past, there is very little data on the recognition of picture books. Moreover, one picture may vary significantly with different environmental and illumination conditions, thus a lot of picture training is required. The image recognition approach in the prior art has a problem of high recognition error rate when used for picture book recognition.

### SUMMARY

According to a first aspect of the present invention, there is provided a picture book recognition method applied to an apparatus with a camera, comprising:

acquiring an image of the picture book with the camera at a preset acquisition frequency;

uploading the image to a server;

receiving a first audio link corresponding to the image returned from the server and, if the image is an image of a cover of the picture book, receiving a picture book ID corresponding to the cover image; and

connecting to a first audio stream in the server and playing the audio according to the first audio link.

Optionally, the method further comprises:

receiving a page turning instruction returned from the server;

acquiring a new image of the picture book with the camera at a preset acquisition frequency;

uploading the new image and the picture book ID to the server;

receiving a second audio link corresponding to the new image returned from the server; and

connecting to a second audio stream in the server and playing the audio according to the second audio link.

Optionally, the method further comprises receiving a start signal to give a prompt tone or a prompt message.

According to a second aspect of the present invention, there is provided a picture book recognition method applied to an apparatus with a camera, comprising:

receiving an image of the picture book;

recognizing the image to obtain a recognition result and a score corresponding to the recognition result;

returning a first audio link corresponding to the recognition result having a score higher than a score threshold and, if the image is a cover image of the picture book, returning a picture book ID corresponding to the cover image; and

transmitting a first audio stream according to the first audio link.

Optionally, recognizing the image comprises:

comparing the image with cover images of picture books stored in the database;

recognizing the image as a cover image if it matches any of the cover images of picture books stored in the database;

determining whether the image carries a picture book ID if it does not match any of the cover images of picture books stored in the database; and

if the image carries a picture book ID, determining a corresponding picture book according to the picture book ID, and comparing the image with inside page images of the corresponding picture book stored in the database.

Optionally, the method further comprises:

recognizing the image as an image of an inside page of the picture book if it matches any of the inside page images of the corresponding picture book stored in the database; and

recognizing the image as an image not included in the picture book, or an image of a cover of a new picture book if it does not match any of the inside page images of the corresponding picture book stored in the database.

Optionally, the image is at least two images that are consecutively acquired.

Recognizing the image to obtain a recognition result and a score corresponding to the recognition result comprises:

recognizing each of the images; and

if the recognition result of each image is the same, outputting the recognition result and the score corresponding to the recognition result.

Optionally, the method further comprises:

continuously receiving images; and

recognizing the images to obtain the recognition result; and

determining that a page of the picture book is turned and returning a page turning instruction if the recognition result is different from the previous recognition result.

Optionally, the method further comprises:

receiving a new image and picture book ID thereof;

recognizing the new image to obtain a recognition result and a score corresponding to the recognition result;

returning a second audio link having a score higher than a score threshold; and

transmitting a second audio stream according to the second audio link.

According to a third aspect of the present invention, there is provided a picture book recognition apparatus, comprising:

an acquiring module configured to acquire an image of the picture book at a preset acquisition frequency;

an uploading module configured to upload the image to a server;

a first receiving module configured to receive a first audio link corresponding to the image returned from the server and, if the image is an image of a cover of the picture book, receive a picture book ID corresponding to the cover image; and

a playing module configured to connect to a first audio stream in the server and playing the audio according to the first audio link.

Optionally, the acquiring module is further configured to acquire a new image of the picture book at a preset acquisition frequency;

the uploading module is further configured to upload the new image and the picture book ID to the server;

the first receiving module is configured to receive a page turning instruction returned from the server, and receive a second audio link corresponding to the new image returned from the server; and

the playing module is further configured to connect to a second audio stream in the server and playing the audio according to the second audio link.

Optionally, the apparatus further comprises a prompt module configured to receive a start signal to give a prompt tone or a prompt message.

According to a fourth aspect of the present invention, there is provided a picture book recognition apparatus, comprising:

a second receiving module configured to receive an image of the picture book;

a recognizing module configured to recognize the image to obtain a recognition result and a score corresponding to the recognition result;

a sending module configured to return a first audio link corresponding to the recognition result having a score higher than a score threshold and, if the image is an image of a cover of the picture book, return a picture book ID corresponding to the cover image; and

a transmitting module configured to transmit a first audio stream according to the first audio link.

Optionally, the recognizing module is particularly configured to:

compare the image with cover images of picture books stored in the database;

recognize the image as the cover image if it matches any of the cover images stored in the database;

determine whether the image carries a picture book ID if it does not match any of the cover images stored in the database; and

if the image carries a picture book ID, determine a corresponding picture book according to the picture book ID, and compare the image with inside page images of the corresponding picture book stored in the database.

Optionally, the recognizing module is particularly configured to:

recognize the image as an image of an inside page of the picture book if it matches any of the inside page images of the corresponding picture book stored in the database; and

recognize the image as an image not included in the picture book, or an image of a cover of a new picture book if it does not match any of the inside page images of the corresponding picture book stored in the database.

Optionally, the image is at least two images that are consecutively acquired.

The recognizing module is particularly configured to:

recognize each of the images; and

if the recognition result of each image is the same, output the recognition result and the score corresponding to the recognition result.

Optionally, the second receiving module is further configured to continuously receive images;

the recognizing module is configured to recognize the images to obtain the recognition result and determine that a page of the picture book is turned if the recognition result is different from the previous recognition result;

the sending module is further configured to return a page turning instruction.

Optionally, the second receiving module is further configured to receive a new image and picture book ID thereof;

the recognizing module is further configured to recognize the new image to obtain a recognition result and a score corresponding to the recognition result;

the sending module is further configured to return a second audio link having a score higher than a score threshold; and

the transmitting module is further configured to transmit a second audio stream according to the second audio link.

According to a fifth aspect of the present invention, there is provided a picture book recognition system comprising an apparatus comprising an acquiring module, uploading module, first receiving module and playing module as described above and an apparatus comprising a second receiving module, recognizing module, sending module and transmitting module as described above.

According to a sixth aspect of the present invention, there is provided an electronic device comprising:

a camera for acquiring images;

at least one first processor; and

a first memory communicatively coupled to the at least one first processor;

wherein the first memory stores instructions executable by the at least one first processor, the instructions being executed by the at least one first processor to enable the at least one first processor to carry out the method according to the first aspect of the present invention as described above.

According to a seventh aspect of the present invention, there is provided an electronic device comprising:

at least one second processor; and

a second memory communicatively coupled to the at least one second processor;

wherein the second memory stores instructions executable by the at least one second processor, the instructions being executed by the at least one second processor to enable the at least one second processor to carry out the method according to the second aspect of the present invention as described above.

According to the picture book recognition method, apparatus, system and electronic device provided by the present invention, the image of the picture book is automatically acquired by the camera and uploaded to the server, then an ID of the picture book is received when the image is recognized as an image of the cover of the picture book, whereby the server is enabled to determine which picture book the subsequently uploaded image carrying the picture book ID comes from. After determining the picture book, it is possible to constrain the feature retrieval library of the picture book, thus reducing the retrieval time and eliminating a large number of erroneous book pages with high similarity, whereby faster and more accurate key feature retrieval is achieved.

### BRIEF DESCRIPTION OF THE DRAWINGS

FIG. 1 is a schematic flow chart of a first embodiment of the picture book recognition method provided by the present invention;

FIG. 2 is a schematic flow chart of a second embodiment of the picture book recognition method provided by the present invention;

FIG. 3a is a schematic flow chart illustrating a third embodiment of the picture book recognition method provided by the present invention;

FIG. 3b is a specific flow chart of an embodiment of step 302 in the third embodiment of the picture book recognition method provided by the present invention;

FIG. 4 is a schematic flow chart of a fourth embodiment of the picture book recognition method provided by the present invention;

FIG. 5 is a schematic structural diagram of a first embodiment of the picture book recognition apparatus provided by the present invention;

FIG. 6 is a schematic structural diagram of a second embodiment of the picture book recognition apparatus provided by the present invention;

FIG. 7 is a schematic structural diagram of a third embodiment of the picture book recognition apparatus provided by the present invention;

FIG. 8 is a schematic structural diagram of a first embodiment of the electronic device provided by the present invention; and

FIG. 9 is a schematic structural diagram of a second embodiment of the electronic device provided by the present invention.

### DETAILED DESCRIPTION OF THE INVENTION

To better understand the objectives, technical solutions, and advantages of the present invention, the present invention is further described in detail below in combination with embodiments with reference to the accompanying drawings.

It should be noted that the use of terms “first” and “second” in the embodiments of the present invention is to distinguish two different entities or parameters with the same name. It is appreciated that the terms “first” and “second” are merely for convenience of description and are not to be construed as limitations on the embodiments of the invention.

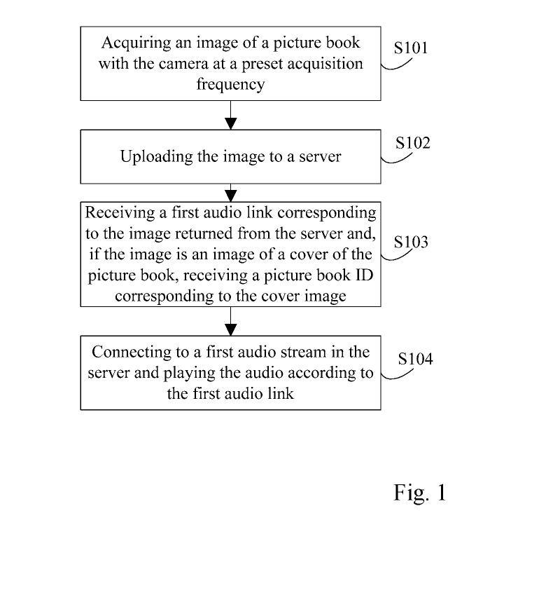

According to a first aspect of the present invention, there is provided a picture book recognition method capable of improving the recognition accuracy. FIG. 1 is a schematic flow chart of a first embodiment of the picture book recognition method provided by the present invention.

The method is applied to an apparatus with a camera, comprising the following steps:

S101: acquiring an image of the picture book with the camera at a preset acquisition frequency. The acquisition frequency may be a default value or may be defined according to user's requirements. Optionally, the acquisition frequency may be 200 ms. The camera may be a camera on any electronic device (such as a cell phone, tablet, camera, etc.), or may be a camera installed in an acquisition device specially designed based on the present invention. The image refers to that obtained by shooting the picture book with the camera and it may be an image of a cover or an inside page of the picture book depending on to which page of the picture book the user currently turns.

S102: uploading the image to a server such that the server can recognize the image.

Optionally, prior to being uploaded the image may be subject to various processing, including but not limited to compression, blur image filtration, image binaryzation, grayscale processing, Scale Invariant feature extraction, and intersection feature extraction. The image may be uploaded through WiFi after the WiFi module is connected to a broadband network, or through a mobile network when the uploading client is a smart device such as mobile phone.

S103: receiving from the sever a first audio link corresponding to the image (namely, corresponding to the recognition result) if the server determines that the recognition result meets the requirements; if the image is a cover image and it is thus determined that the user is reading picture book corresponding to the cover image, receiving a picture book ID corresponding to the cover image (namely, ID of the picture book corresponding to the cover image), wherein the picture book ID is carried by the subsequently uploaded images such that it can be used by the server for picture book determination, the first audio link may be a URL (Uniform Resource Locator) corresponding to the audio.

S104: connecting to a first audio stream in the server and playing the audio according to the first audio link. The audio played may be an audio matching a page of the picture book corresponding to the image, it may read all texts contained on that page or, in some cases, a portion of the texts, or additionally, texts not contained on that page. In the case that the audio reads all texts contained on the page, the reading may be performed from top to bottom and from left to right.

According to the embodiment of picture book recognition method described above, the image of the picture book is automatically acquired by the camera and uploaded to the server, then an ID of the picture book is received when the image is recognized as an image of the cover of the picture book, whereby the server is enabled to determine which picture book the subsequently uploaded image carrying the picture book ID comes from. After determining the picture book, it is possible to constrain the feature retrieval library of the picture book, thus reducing the retrieval time and eliminating a large number of erroneous book pages with high similarity, whereby faster and more accurate key feature retrieval is achieved.

According to some optional embodiments, the picture book recognition method further comprises:

receiving a page turning instruction returned from the server; the page turning instruction is returned from the server when the server determines that a page of the picture book is turned by the user based on the variation in the continuously received images; there are various ways for determining whether the page is turned, optionally, the determination may be carried out through image comparison in which it is determined that page turning occurs when the continuously received images are different;

acquiring a new image of the picture book with the camera at a preset acquisition frequency; here, the new image refers to an image different from the previously uploaded image, namely, it is an image of a new page of the picture book acquired after the page is turned to;

uploading the new image and the picture book ID to the server; in this case, the new image carries the picture book ID such that the server can determine the picture book according to the picture book ID and compare the new image with inside page images of the corresponding picture book, whereby a more accurate recognition result can be obtained;

receiving a second audio link corresponding to the new image returned from the server; and

connecting to a second audio stream in the server and playing the audio according to the second audio link.

According to the embodiment described above, after the page turning instruction is received, the uploaded new images may carry the picture book ID such that the server can determine the corresponding picture book according to the picture book ID and compare the new images with the inside page images of the picture book, in this way it is made possible to constrain the feature retrieval library of the picture book, thus reducing the retrieval time and eliminating a large number of erroneous inside page images with high similarity, whereby a more accurate recognition result can be obtained.

In addition to determining page turning based on the page turning instruction described above, in some optional embodiments the picture book recognition method further comprises the following steps for determining page turning:

continuously acquiring images;

receiving recognition result corresponding to each of the images from the server;

storing the recognition result as a recognition result sequence in which at least two recognition results are stored;

comparing the recognition results in the recognition result sequence;

determining occurrence of the page turning if a subsequent recognition result is different from a previous recognition result in the sequence.

The page turning determination process may be performed at the device in order to enhance the response speed.

Preferably, in some optional embodiments, a plurality of consecutive recognition results is stored in the recognition result sequence.

After comparing the recognition results in the sequence, the method may further comprise:

if the subsequent recognition result in the recognition result queue is different from the previous recognition result and three consecutive subsequent recognition results are the same, determining that the page turning is performed; otherwise, retaining the previous recognition result; and optionally, deleting the subsequent recognition result, so as to save the storage space on the device.

According to the above embodiment, it is determined the page turning is performed only when the subsequent recognition results are continuous, so as to ensure the determination accuracy and exclude some uncertain factors (for example, errors recognition caused by the unclear image, or the uncertainty caused by the user's page turning back and forth, etc.).

In addition to determining page turning based on the page turning instruction described above, in some optional embodiments the picture book recognition method further comprises the following steps for determining page turning:

continuously acquiring images;

receiving recognition result corresponding to each of the images from the server;

storing the recognition result as a recognition result sequence in which a plurality of recognition results is stored; preferably, 15 recognition results are stored in the recognition result sequence;

dividing the plurality of recognition results into at least two sets; optionally, the plurality of recognition results may be divided into three sets;

assigning a different weight to each of the sets; wherein the weight is decreased according to the order of reception time of the recognition results in each set; optionally, in the case of three sets, a first weight for the first set (containing the earliestly received recognition results) is 0.6, a second weight for the second set is 0.3, and a third weight for the third set (containing the latest received recognition results) is 0.1;

determining the ratio of the latest recognition results (for example, there are 15 recognition results in the recognition result sequence, of which the first five recognition results are A, the middle five recognition results are B, the last five recognition results are C, then the latest recognition results are C) in the respective set (for example, if the set includes five recognition results, of which two are the latest, then the ratio is ⅖); it is assumed that the ratio of the latest recognition results in the first set is the first ratio, the ratio of the latest recognition results in the second set is the second ratio, and the ratio of the latest recognition results in the third set is the third ratio; optionally, whether a recognition result is the latest recognition result may be determined based on the time stamp carried by the recognition result;

calculating an effective value of the latest recognition results in the entire recognition result sequence; preferably, the effective value may be calculated as follows:

effective value=first weight*first weight+second weight*second weight+third weight*third weight;

determining that the page turning is performed; otherwise, retaining the previous recognition results; and optionally, deleting the subsequent recognition results, so as to save the storage space on the device. Optionally, the preset effective value threshold may be a default setting of the system, or may be customized according to requirements of the user or service provider. The specific preset effective value threshold may be selected to enable determination of the page turning.

According to the embodiment described above, it is determined that the page turning is performed only when the effective value of the latest recognition results reaches a certain level, whereby the determination accuracy is ensured.

According to some optional embodiments, the picture book recognition method further comprises:

receiving a start signal to give a prompt tone and/or a prompt message. Optionally, the start signal may be a power-on signal of the device, or an activation signal generated when a corresponding APP is opened when the picture book recognition method is implemented with the APP on the mobile phone; the prompt tone may be any sound capable of promotion; the prompt message may be a text displayed on the screen of the device, for example, “Welcome to use the picture book recognition tool, please take a picture of the book cover.” The prompt tone and the prompt message may be used separately or in combination. The main purpose of both is to prompt the user to first photograph the picture book cover, so that the server can recognize the picture book cover and determine the picture book ID, in order to constrain the feature retrieval library for subsequent recognition of the inside pages of the picture book.

According to some optional embodiments, the picture book recognition method further comprises:

comparing the acquired images; and

deleting images exceeding a preset threshold when the number of the same images exceeds the preset threshold. For example, in the case that eight consecutively acquired images are the same, if the preset threshold is five, then three of the eight same images are deleted. Optionally, the preset threshold may be a default setting of the system, or may be customized according to requirements of the user or service provider. Preferably, the specific preset threshold may be selected to enable determination of the recognition results.

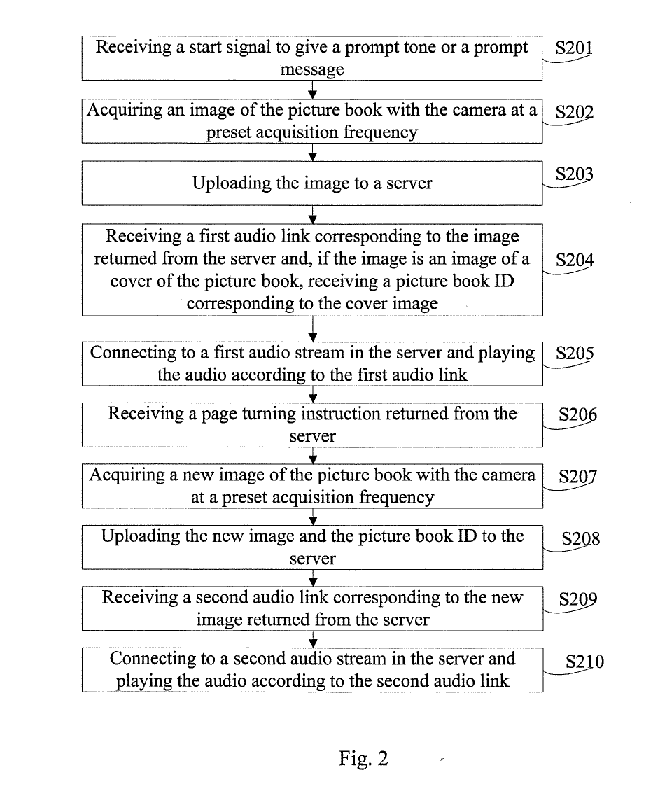

The present invention further provides a second embodiment of the picture book recognition method capable of improving the recognition accuracy. FIG. 2 is a schematic flow chart of the second embodiment of the picture book recognition method provided by the present invention.

The method is applied to an apparatus with a camera, comprising the following steps:

S201: receiving a start signal to give a prompt tone or a prompt message;

S202: acquiring an image of the picture book with the camera at a preset acquisition frequency;

S203: uploading the image to a server;

S204: receiving a first audio link corresponding to the image returned from the server and, if the image is an image of a cover of the picture book, receiving a picture book ID corresponding to the cover image;

S205: connecting to a first audio stream in the server and playing the audio according to the first audio link;

S206: receiving a page turning instruction returned from the server;

S202: acquiring a new image of the picture book with the camera at a preset acquisition frequency;

S208: uploading the new image and the picture book ID to the server;

S209: receiving a second audio link corresponding to the new image returned from the server; and

S210: connecting to a second audio stream in the server and playing the audio according to the second audio link.

According to the embodiment of the picture book recognition method described above, the image of the picture book is acquired with the camera and uploaded to the server, the server determines that image is a cover of a certain picture book and returns a corresponding audio link and picture book ID, the device connects to the audio stream and plays the audio and after it is determined that a page of the picture book is turned, an image and the picture book ID are uploaded to the server. With the picture book ID, the feature retrieval library of the inside pages of the picture book is constrained, the retrieval time is reduced and a large number of erroneous book pages with high similarity is eliminated, whereby the recognition accuracy is enhanced and the recognition time is reduced.

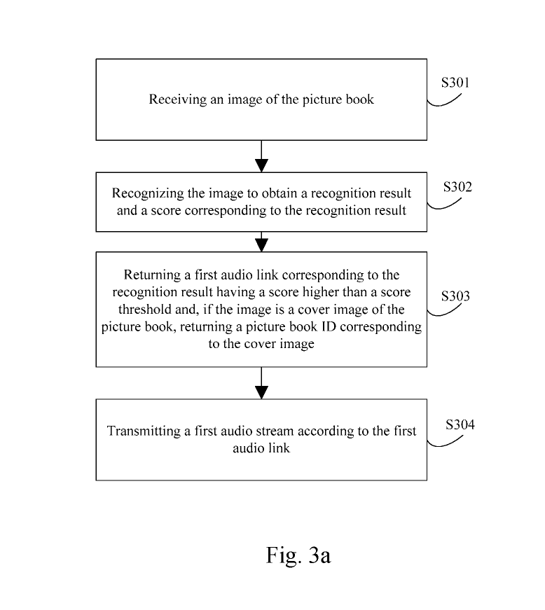

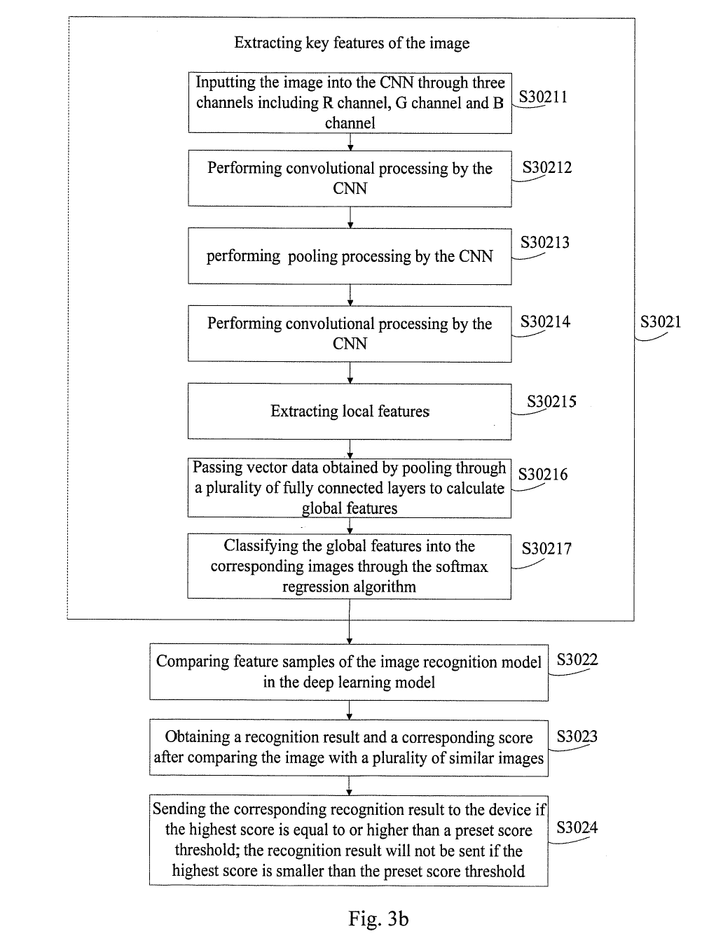

According to a second aspect of the present invention, there is provided a picture book recognition method capable of improving the recognition accuracy. FIG. 3a is a schematic flow chart of a third embodiment of the picture book recognition method provided by the present invention.

Optionally, the method is applied to a sever capable of image recognition, comprising the following steps:

S301: receiving an image of a picture book;

S302: recognizing the image to obtain a recognition result and a score corresponding to the recognition result. Optionally, the image is recognized using an image recognition model capable of image recognition and providing a score corresponding to the recognition result. The score may be determined according to various parameters, one of which may be the similarity between the image and the picture book corresponding to the recognition result.

S303: returning a first audio link (optionally, a URL of an audio corresponding to a picture book page corresponding to the image) corresponding to the recognition result having a score higher than a score threshold; and if the image is a cover image of the picture book and it is thus determined that the user is reading the picture book corresponding to the cover image, returning a picture book ID corresponding to the cover image (namely, ID of the picture book corresponding to the cover image), wherein the picture book ID is carried by the images subsequently uploaded from the device such that it can be used for picture book determination. Optionally, the score threshold may be a default setting of the system, or may be customized according to requirements of the user or service provider. Preferably, the specific score threshold may be selected to impart the recognition result with a high accuracy.

S304: transmitting a first audio stream according to the first audio link.

According to the embodiment of picture book recognition method described above, the server recognizes the received image of the picture book that is automatically acquired, and returns to the device an ID of the picture book when the image is recognized as an image of the cover of the picture book, whereby the mage subsequently uploaded from the device can carry the picture book ID and the server is enabled to determine which picture book the subsequently uploaded image comes from. After determining the picture book, it is possible to constrain the feature retrieval library of the picture book, thus reducing the retrieval time and eliminating a large number of erroneous book pages with high similarity, whereby faster and more accurate key feature retrieval is achieved.

Reference is now made to FIG. 3b. According to some optional embodiments, S302 of recognizing the image to obtain a recognition result and a score corresponding to the recognition result may perform image recognition by computer vision technology, for example, deep learning algorithm and comprise in particular the following steps:

S3021: extracting key features of the image;

The image recognition may comprise image classification based on deep convolutional neural networks. For each image of the picture book (including the cover and the inside page), the key areas of the image may be extracted locally in advance to reduce the background interference. At the same time, for each image of the picture book, 100 images are obtained with different illumination conditions at different angles for DNN (Deep Neural Network) training. With the aid of these means, it is possible to achieve high recognition accuracy. Optionally, in the case that each recognition starts with recognizing whether the image is a cover image of the picture book, the preprocessing steps herein may only be performed on the book cover in order to improve the recognition accuracy, reduce the amount of processing, and save system resources.

Further, S3021 of extracting key features of the image is based on deep learning algorithm and may comprise the following steps:

S30211: inputting the image (including the cover and inside page) into the CNN (Convolutional Neural Network) through three channels including R channel, G channel and B channel;

S30212: performing convolutional processing by the CNN;

S30213: performing pooling processing by the CNN;

S30214: repeating S30212 and S30213 for multiple times in order to extract local features;

S30215: passing vector data obtained by pooling through a plurality of fully connected layers to calculate global features;

S30216: classifying the global features into the corresponding images through the softmax regression algorithm to get the feature samples of the image recognition model in the deep learning model. Optionally, in the case that each recognition starts with recognizing whether the image is a cover image of the picture book, the preprocessing steps herein may only be performed on the book cover in order to improve the recognition accuracy, reduce the amount of processing, and save system resources.

S3022: comparing feature samples of the image recognition model in the deep learning model. Optionally, if the image recognition model is just a cover recognition model for the book cover, then it is more accurate as compared with common object recognizing module since fewer samples need to be compared.

S3023: obtaining a recognition result and a corresponding score after comparing the image with a plurality of similar images, the recognition result may be ranked in an ascending order according to the score.

S3024: sending the corresponding recognition result to the device if the highest score is equal to or higher than a preset score threshold. The recognition result will not be sent if the highest score is smaller than the preset score threshold.

The embodiment described above is only used for cover image recognition, making it possible to enhance recognition accuracy, reduce the amount of processing, and save system resource.

With the deep learning algorithm provided by the above embodiment, the image recognition accuracy is significantly improved.

S302: recognizing the image may further comprises the following steps:

comparing the image with cover images of picture books stored in the database;

recognizing the image as the cover image if it matches any of the cover images stored in the database;

determining whether the image carries a picture book ID if it does not match any of the cover images stored in the database; this picture book ID is the one returned from the server when it determines that the image is a cover image; in the case that the server receives this picture book ID and the image does not match any of the cover images stored in the database, it is required to determine whether the image is an inside page image of the picture book corresponding to the picture book ID;

if the image carries a picture book ID, determining a corresponding picture book according to the picture book ID, and comparing the image with inside page images of the corresponding picture book stored in the database (namely, data set only including inside page images associated with the picture book ID);

recognizing the image as an image of an inside page of the picture book if it matches any of the inside page images of the corresponding picture book stored in the database; and

recognizing the image as an image not included in the picture book, or an image of a cover of a new picture book if it does not match any of the inside page images of the corresponding picture book stored in the database.

The above embodiment provides a specific order of image recognition. By first determining whether the image is a cover image, the database is constrained to the cover image database in order to achieve a quicker and more accurate recognition. In the case that the image is not a cover image, it is determined whether the image carries a picture book ID. When it is determined that the picture book ID is carried, the picture book ID is used to recognize the inside page images such that the database is constrained to the inside page image database corresponding to such picture book ID, whereby a quicker and more accurate recognition is achieved.

Preferably, according to some optional embodiments, in addition to directly comparing the image with inside page images corresponding to the picture book ID, the inside page image recognition may further comprise the following steps:

comparing the image with all inside page images contained in the database;

adding a confidence weight to inside page image associated with the picture book ID; and

obtaining a recognition result and a score corresponding to the recognition result. Since the inside page image associated with the picture book ID is added with the confidence weight, it has a relatively higher score. If the image is not an inside page image associated with the picture book ID, it is also possible to get a correct recognition result in this way.

In some optional embodiments, the image is at least two images that are consecutively acquired.

The step of recognizing the image to obtain a recognition result and a score corresponding to the recognition result comprises:

recognize each of the images; and

if the recognition result of each image is the same, outputting the recognition result and the score corresponding to the recognition result. In the case that the same recognition result is obtained for a plurality of consecutive images, it can be assumed that a page of the picture book is constantly read. In this way, the recognition result is more accurate than the recognition method without processing.

According to some optional embodiments, the picture book recognition method further comprises:

continuously receiving images;

recognizing the images to obtain the recognition result; and

determining that a page of the picture book is turned and returning a page turning instruction if the recognition result is different from the previous recognition result. Optionally, key intersection information in the image is taken as the fingerprint of the image. It is determined that page turning occurs if the images have different fingerprints.

According to the embodiment describe above, page turning is automatically recognized without any further operation of the user.

According to some optional embodiments, the picture book recognition method further comprises:

receiving a new image and picture book ID thereof;

recognizing the new image according to the picture book ID to obtain a recognition result and a score corresponding to the recognition result; namely, determining the corresponding picture book according to the picture book ID and comparing the new image with inside page images of the corresponding picture book, in order to obtain an accurate recognition result;

returning a second audio link having a score higher than a score threshold; and

transmitting a second audio stream according to the second audio link.

Through the above embodiments, the recognition of the image carrying picture book ID is completed, and a new audio link is returned to the device so that the device can play audio related to the new page of the picture book.

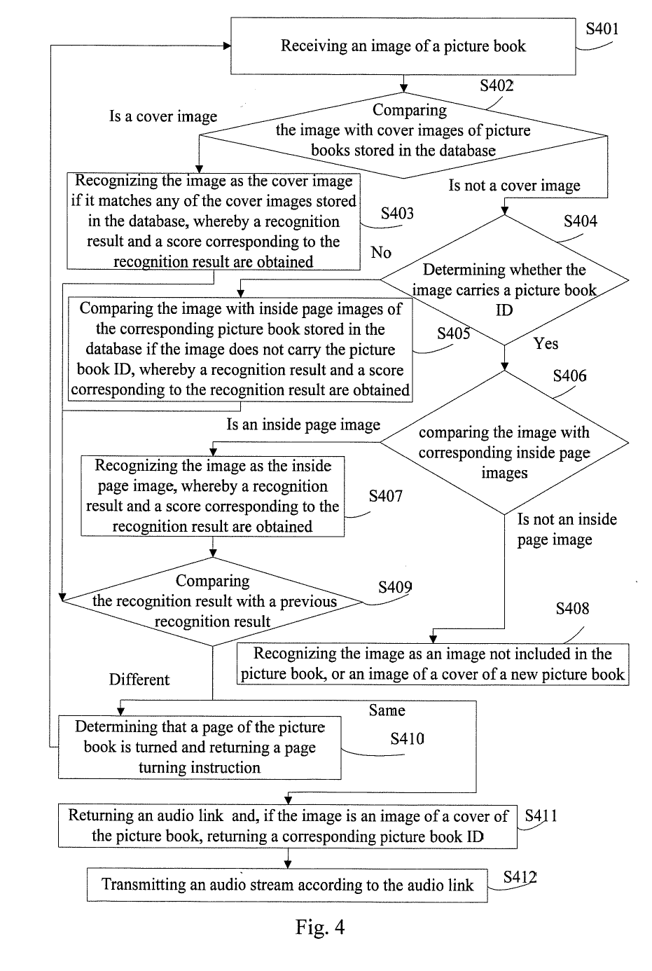

The present invention further provides a fourth embodiment of the picture book recognition method capable of improving the recognition accuracy. FIG. 4 is a schematic flow chart of the fourth embodiment of the picture book recognition method provided by the present invention.

The method comprises the following steps:

S401: receiving an image of a picture book;

S402: comparing the image with cover images of picture books stored in the database;

S403: recognizing the image as the cover image if it matches any of the cover images stored in the database, whereby a recognition result and a score corresponding to the recognition result are obtained;

S404: determining whether the image carries a picture book ID if it does not match any of the cover images of picture books stored in the database; and

S405: comparing the image with inside page images of the corresponding picture book stored in the database if the image does not carry the picture book ID, whereby a recognition result and a score corresponding to the recognition result are obtained;

S406: if the image carries a picture book ID, determining a corresponding picture book according to the picture book ID, and comparing the image with inside page images of the corresponding picture book stored in the database;

S407: recognizing the image as the inside page image if it matches any of the inside page images of the corresponding picture book stored in the database, whereby a recognition result and a score corresponding to the recognition result are obtained;

S408: recognizing the image as an image not included in the picture book, or an image of a cover of a new picture book if it does not match any of the inside page images of the corresponding picture book stored in the database;

S409: comparing the recognition result with a previous recognition result;

S410: determining that a page of the picture book is turned and returning a page turning instruction if the recognition result is different from the previous recognition result, in this case, the method goes back to S401;

S411: returning an audio link corresponding to the recognition result having a score higher than a score threshold if the recognition result is the same as the previous recognition result and, if the image is an image of a cover of the picture book, returning a picture book ID corresponding to the cover image;

S412: transmitting an audio stream according to the audio link.

According to the picture book recognition method provided in the above embodiment, it determines whether an image is a cover image of the picture book by image recognition technology, sends a corresponding audio link and a picture cook ID to the device when it is determined that the image is a cover image, so that the device can connect to the audio stream and play the audio. Moreover, when a page of the picture book is turned, the image subsequently uploaded by the device carries said picture book ID. In this way, the feature retrieval library of the inside pages is constrained, the retrieval time is reduced, and a large number of erroneous pages with high similarity can be eliminated. Accordingly, the goal of enhancing the recognition accuracy and shortening the recognition time is achieved.

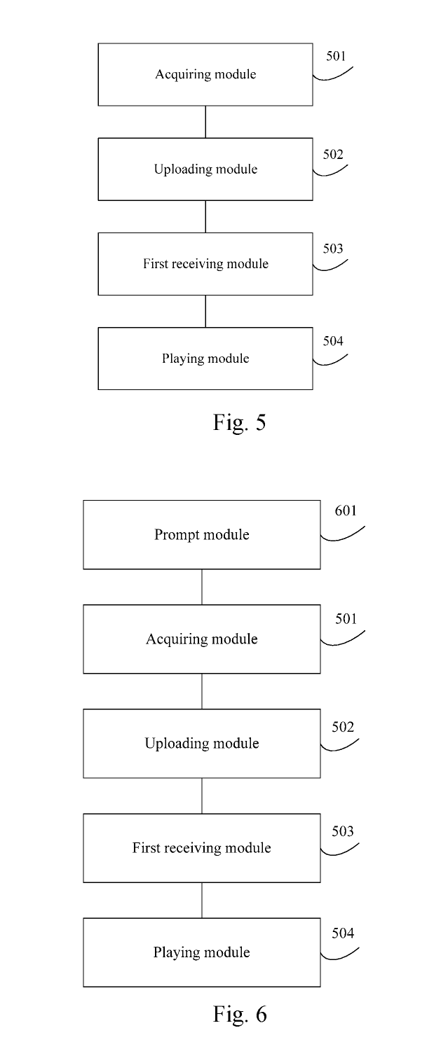

According to a third aspect of the present invention, there is provided a picture book recognition apparatus capable of improving the recognition accuracy. FIG. 5 is a schematic structural diagram of a first embodiment of the picture book recognition apparatus provided by the present invention.

Optionally, the picture book recognition apparatus is an apparatus capable of image acquisition, comprising modules described as follows.

An acquiring module 501 is configured to acquire an image of the picture book at a preset acquisition frequency. The acquisition frequency may be a default value or may be defined according to user's requirements. Optionally, the acquisition frequency may be 200 ms. The acquiring module 501 may include a camera for acquiring images of the picture book, the camera may be a camera on any electronic device (such as a cell phone, tablet, camera, etc.), or may be a camera installed in an acquisition device specially designed based on the present invention. The image refers to that obtained by shooting the picture book with the camera and it may be an image of a cover or an inside page of the picture book depending on to which page of the picture book the user currently turns.

An uploading module 502 is configured to upload the image to a server. Optionally, prior to being uploaded the image may be subject to various processing, including but not limited to compression, blur image filtration, image binaryzation, grayscale processing, Scale Invariant feature extraction, and intersection feature extraction. The image may be uploaded through WiFi after the WiFi module is connected to a broadband network, or through a mobile network when the uploading client is a smart device such as mobile phone.

A first receiving module 503 is configured to receive from the sever a first audio link corresponding to the recognition result (namely, corresponding to the image) if the server determines that the recognition result meets the requirements; and, if the image is a cover image and it is thus determined that the user is reading picture book corresponding to the cover image, receive a picture book ID corresponding to the cover image (namely, ID of the picture book corresponding to the cover image), wherein the picture book ID is carried by the subsequently uploaded images such that it can be used by the server for picture book determination, the first audio link may be a URL (Uniform Resource Locator) corresponding to the audio.

A playing module 504 is configured to connect to a first audio stream in the server and playing the audio according to the first audio link. The audio played may be an audio matching a page of the picture book corresponding to the image, it may read all texts contained on that page or, in some cases, a portion of the texts, or additionally, texts not contained on that page. In the case that the audio reads all texts contained on the page, the reading may be performed from top to bottom and from left to right.

According to the embodiment of picture book recognition apparatus described above, the image of the picture book is automatically acquired by the camera and uploaded to the server, then an ID of the picture book is received when the image is recognized as an image of the cover of the picture book, whereby the server is enabled to determine which picture book the subsequently uploaded image carrying the picture book ID comes from. After determining the picture book, it is possible to constrain the feature retrieval library of the picture book, thus reducing the retrieval time and eliminating a large number of erroneous book pages with high similarity, whereby faster and more accurate key feature retrieval is achieved.

The present invention further provides a second embodiment of the picture book recognition apparatus capable of improving the recognition accuracy. FIG. 6 is a schematic structural diagram of the second embodiment of the picture book recognition apparatus provided by the present invention.

The apparatus comprises modules described as follows.

A prompt module 601 is configured to receive a start signal to give a prompt tone or a prompt message. Optionally, the start signal may be a power-on signal of the device, or an activation signal generated when a corresponding APP is opened when the picture book recognition method is implemented with the APP on the mobile phone; the prompt tone may be any sound capable of promotion; the prompt message may be a text displayed on the screen of the device, for example, “Welcome to use the picture book recognition tool, please take a picture of the book cover.” The prompt tone and the prompt message may be used separately or in combination. The main purpose of both is to prompt the user to first photograph the picture book cover, so that the server can recognize the picture book cover and determine the picture book ID, in order to constrain the feature retrieval library for subsequent recognition of the inside pages of the picture book.

An acquiring module 501 is configured to acquire an image of the picture book at a preset acquisition frequency and, in the case that a page of the picture book is turned, acquired a new image of the picture book.

An uploading module 502 is configured to upload the image to a server and, in the case that a picture book ID is received, upload the new image and the picture book ID to the server.

A first receiving module 503 is configured to receive from the sever a first audio link corresponding to the image; if the image is a cover image, receive a picture book ID corresponding to the cover image; receive a page turning instruction returned from the server; and receive from the server a second audio link corresponding to the new image.

A playing module 504 is configured to connect to a first audio stream in the server and playing the audio according to the first audio link, and connect to a second audio stream in the server and playing the audio according to the second audio link.

According to the embodiment of the picture book recognition method described above, the image of the picture book is acquired with the camera and uploaded to the server, the server determines that image is a cover of a certain picture book and returns a corresponding audio link and picture book ID, the device connects to the audio stream and plays the audio and after it is determined that a page of the picture book is turned, an image and the picture book ID are uploaded to the server. With the picture book ID, the feature retrieval library of the inside pages of the picture book is constrained, the retrieval time is reduced and a large number of erroneous book pages with high similarity is eliminated, whereby the recognition accuracy is enhanced and the recognition time is reduced.

According to some optional embodiments, the picture book recognition apparatus further comprises a filtering module configured to:

compare the acquired images; and

delete images exceeding a preset threshold when the number of the same images exceeds the preset threshold. For example, in the case that eight consecutively acquired images are the same, if the preset threshold is five, then three of the eight same images are deleted. Optionally, the preset threshold may be a default setting of the system, or may be customized according to requirements of the user or service provider. Preferably, the specific preset threshold may be selected to enable determination of the recognition results.

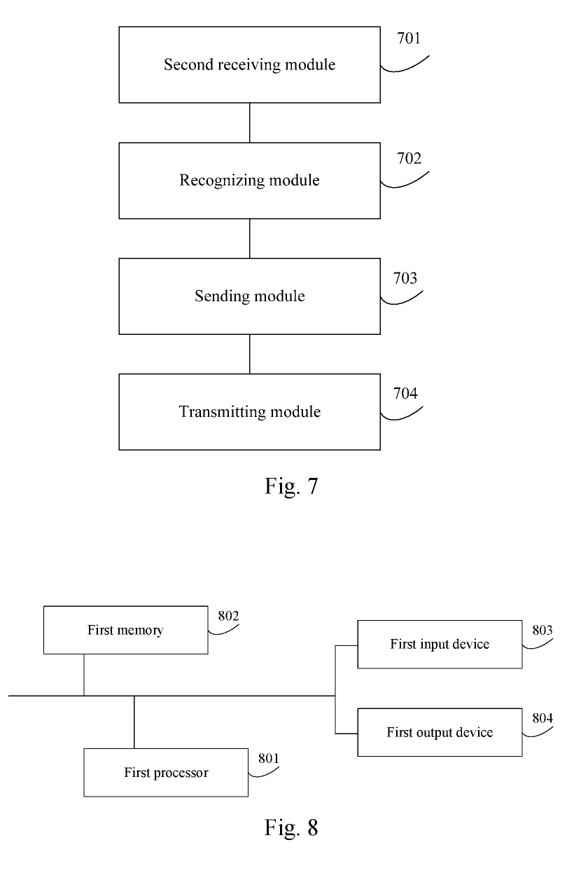

According to a fourth aspect of the present invention, there is provided a picture book recognition apparatus capable of improving the recognition accuracy. FIG. 7 is a schematic structural diagram of a third embodiment of the picture book recognition apparatus provided by the present invention.

Optionally, the picture book recognition apparatus is a server capable of image recognition, comprising modules described as follows.

A second receiving module 701 is configured to receive an image of the picture book.

A recognizing module 702 is configured to recognize the image to obtain a recognition result and a score corresponding to the recognition result. Optionally, the image is recognized using an image recognition model capable of image recognition and providing a score corresponding to the recognition result. The score may be determined according to various parameters, one of which may be the similarity between the image and the picture book corresponding to the recognition result.

A sending module 703 is configured to return a first audio link (optionally, a URL of an audio corresponding to a picture book page corresponding to the image) corresponding to the recognition result having a score higher than a score threshold; and if the image is a cover image of the picture book and it is thus determined that the user is reading the picture book corresponding to the cover image, returning a picture book ID corresponding to the cover image (namely, ID of the picture book corresponding to the cover image), wherein the picture book ID is carried by the images subsequently uploaded from the device such that it can be used for picture book determination. Optionally, the score threshold may be a default setting of the system, or may be customized according to requirements of the user or service provider. Preferably, the specific score threshold may be selected to impart the recognition result with a high accuracy.

A transmitting module 704 is configured to transmit a first audio stream according to the first audio link.

According to the embodiment of picture book recognition apparatus described above, the server recognizes the received image of the picture book that is automatically acquired, and returns to the device an ID of the picture book when the image is recognized as an image of the cover of the picture book, whereby the mage subsequently uploaded from the device can carry the picture book ID and the server is enabled to determine which picture book the subsequently uploaded image comes from. After determining the picture book, it is possible to constrain the feature retrieval library of the picture book, thus reducing the retrieval time and eliminating a large number of erroneous book pages with high similarity, whereby faster and more accurate key feature retrieval is achieved.

Reference is now made to FIG. 3b. According to some optional embodiments, the recognizing module 702 is configured to recognize the image by computer vision technology, for example, deep learning algorithm and to perform the following steps:

S3021: extracting key features of the image;

The image recognition may comprise image classification based on deep convolutional neural networks. For each image of the picture book (including the cover and the inside page), the key areas of the image may be extracted locally in advance to reduce the background interference. At the same time, for each image of the picture book, 100 images are obtained with different illumination conditions at different angles for DNN (Deep Neural Network) training. With the aid of these means, it is possible to achieve high recognition accuracy. Optionally, in the case that each recognition starts with recognizing whether the image is a cover image of the picture book, the preprocessing steps herein may only be performed on the book cover in order to improve the recognition accuracy, reduce the amount of processing, and save system resources.

Further, S3021 of extracting key features of the image is based on deep learning algorithm and may comprise the following steps:

S30211: inputting the image (including the cover and inside page) into the CNN (Convolutional Neural Network) through three channels including R channel, G channel and B channel;

S30212: performing convolutional processing by the CNN;

S30213: performing pooling processing by the CNN;

S30214: repeating S30212 and S30213 for multiple times in order to extract local features;

S30215: passing vector data obtained by pooling through a plurality of fully connected layers to calculate global features;

S30216: classifying the global features into the corresponding images through the softmax regression algorithm to get the feature samples of the image recognition model in the deep learning model. Optionally, in the case that each recognition starts with recognizing whether the image is a cover image of the picture book, the preprocessing steps herein may only be performed on the book cover in order to improve the recognition accuracy, reduce the amount of processing, and save system resources.

S3022: comparing feature samples of the image recognition model in the deep learning model. Optionally, if the image recognition model is just a cover recognition model for the book cover, then it is more accurate as compared with common object recognizing module since fewer samples need to be compared.

S3023: obtaining a recognition result and a corresponding score after comparing the image with a plurality of similar images, the recognition result may be ranked in an ascending order according to the score.

S3024: sending the corresponding recognition result to the device if the highest score is equal to or higher than a preset score threshold. The recognition result will not be sent if the highest score is smaller than the preset score threshold.

The embodiment described above is only used for cover image recognition, making it possible to enhance recognition accuracy, reduce the amount of processing, and save system resource.

With the deep learning algorithm provided by the above embodiment, the image recognition accuracy is significantly improved.

According to some optional embodiments, the recognizing module 702 is further configured to:

compare the image with cover images of picture books stored in the database;

recognizing the image as the cover image if it matches any of the cover images stored in the database;

determining whether the image carries a picture book ID if it does not match any of the cover images stored in the database; this picture book ID is the one returned from the server when it determines that the image is a cover image; in the case that the server receives this picture book ID and the image does not match any of the cover images stored in the database, it is required to determine whether the image is an inside page image of the picture book corresponding to the picture book ID;

if the image carries a picture book ID, determining a corresponding picture book according to the picture book ID, and comparing the image with inside page images of the corresponding picture book stored in the database (namely, data set only including inside page images associated with the picture book ID);

recognizing the image as an image of an inside page of the picture book if it matches any of the inside page images of the corresponding picture book stored in the database; and

recognizing the image as an image not included in the picture book, or an image of a cover of a new picture book if it does not match any of the inside page images of the corresponding picture book stored in the database.

The above embodiment provides a specific order of image recognition. By first determining whether the image is a cover image, the database is constrained to the cover image database in order to achieve a quicker and more accurate recognition. In the case that the image is not a cover image, it is determined whether the image carries a picture book ID. When it is determined that the picture book ID is carried, the picture book ID is used to recognize the inside page images such that the database is constrained to the inside page image database corresponding to such picture book ID, whereby a quicker and more accurate recognition is achieved.

Preferably, according to some optional embodiments, in addition to directly comparing the image with inside page images corresponding to the picture book ID, the recognizing module 702 is further configured to perform the following steps:

comparing the image with all inside page images contained in the database;

adding a confidence weight to inside page image associated with the picture book ID;

obtaining a recognition result and a score corresponding to the recognition result. Since the inside page image associated with the picture book ID is added with the confidence weight, it has a relatively higher score. If the image is not an inside page image associated with the picture book ID, it is also possible to get a correct recognition result in this way.

In some optional embodiments, the image is at least two images that are consecutively acquired.

The recognizing module 702 is particularly configured to:

recognize each of the images; and

if the recognition result of each image is the same, outputting the recognition result and the score corresponding to the recognition result. In the case that the same recognition result is obtained for a plurality of consecutive images, it can be assumed that a page of the picture book is constantly read. In this way, the recognition result is more accurate than the recognition method without processing.

According to some optional embodiments, the second receiving module 701 is further configured to continuously receive images.

The recognizing module 702 is configured to recognize the images to obtain the recognition result and determine that a page of the picture book is turned if the recognition result is different from the previous recognition result.

The sending module 703 is further configured to return a page turning instruction. Optionally, key intersection information in the image is taken as the fingerprint of the image. It is determined that page turning occurs if the images have different fingerprints.

According to the embodiment describe above, page turning is automatically recognized without any further operation of the user.

According to some optional embodiments, the second receiving module 701 is further configured to receive a new image of the picture book and picture book ID thereof.

The recognizing module 702 is further configured to recognize the new image according to the picture book ID to obtain a recognition result and a score corresponding to the recognition result; namely, determining the corresponding picture book according to the picture book ID and comparing the new image with inside page images of the corresponding picture book, in order to obtain an accurate recognition result.

The sending module 703 is further configured to return a second audio link having a score higher than a score threshold.

The transmitting module 704 is further configured to transmit a second audio stream according to the second audio link.

Through the above embodiments, the recognition of the image carrying picture book ID is completed, and a new audio link is returned to the device so that the device can play audio related to the new page of the picture book.

According to a fifth aspect of the present invention, there is provided a picture book recognition system capable of improving the recognition accuracy.

The system comprises an apparatus according to any one of the embodiments provided in the third aspect of the present invention (see FIGS. 5 and 6), and an apparatus according to any of the embodiments provided in the fourth aspect of the present invention (see FIG. 7).

According to the embodiment of picture book recognition system described above, the image of the picture book is automatically acquired by the camera and uploaded to the server, then an ID of the picture book is received when the image is recognized as an image of the cover of the picture book, whereby the server is enabled to determine which picture book the subsequently uploaded image carrying the picture book ID comes from. After determining the picture book, it is possible to constrain the feature retrieval library of the picture book, thus reducing the retrieval time and eliminating a large number of erroneous book pages with high similarity, whereby faster and more accurate key feature retrieval is achieved.

According to a sixth aspect of the present invention, there is provided an electronic device capable of improving the recognition accuracy. FIG. 8 is a schematic structural diagram of a first embodiment of the electronic device provided by the present invention.

As shown in FIG. 8, the electronic device comprises:

a camera for acquiring images; and

one or more first processors 801 and a first memory 802. As an example, only one processor 801 is shown in FIG. 8.

The electronic device configured to perform the picture book recognition method further comprises a first input device 803 and a first output device 804.

The first processor 801, the first memory 802, the first input device 803, and the first output device 804 may be connected by a bus or other means. In FIG. 8, the bus connection is taken as an example.

The first memory 802 is a non-transitory computer-readable storage medium that may be used to store non-volatile software programs, non-volatile computer executable programs and modules, such as program instructions/modules corresponding to the picture book recognition method provided in the embodiments of the present invention, for example, the acquiring module 501, the uploading module 502, the first receiving module 503 and the playing module 504 as shown in FIG. 5. The first processor 801 executes various functional applications and data processing of the server (namely, the picture book recognition method provided in the embodiments of the present invention) by running the non-volatile software program, instructions, and modules stored in the first memory 802.

The first memory 802 may include a program storage area and a data storage area, wherein the program storage area may store an operating system, and an application program required by at least one function, and the data storage area may store data created based on the use of the data recommendation device, and the like. In addition, the first memory 802 may include a high-speed random access memory and may further include a non-volatile memory such as at least one magnetic disk storage device, flash memory device, or other non-volatile solid-state storage device. In some embodiments, the first memory 802 optionally includes memories remotely located relative to the first processor 801, and these remote memories may be connected to a user behavior monitoring device through the network. Examples of the network include, but are not limited to, the Internet, an intranet, a local area network, a mobile communication network, and combinations thereof.

The first input device 803 may receive input digits or characters and generate a key signal input related to user setting and function control of the picture book recognition apparatus. The first output device 804 may include a display device such as a display screen.

The one or more modules are stored in the first memory 802 and, when executed by the one or more first processors 801, perform the picture book recognition method according to any of the above method embodiments. An embodiment of the electronic device that executes the picture book recognition method can produce the same or similar technical effects as the foregoing method embodiments.

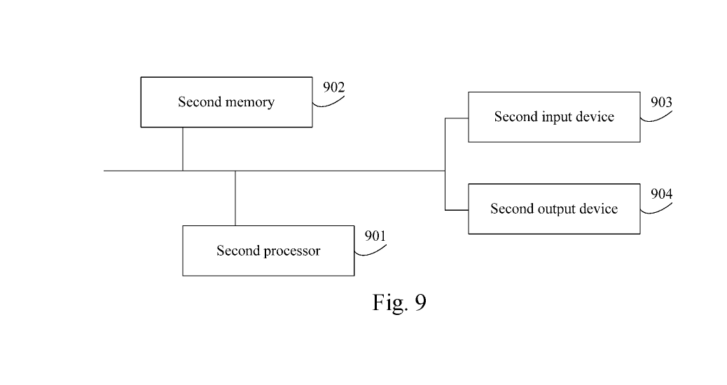

According to a seventh aspect of the present invention, there is provided an electronic device capable of improving the recognition accuracy. FIG. 9 is a schematic structural diagram of a second embodiment of the electronic device provided by the present invention.

As shown in FIG. 9, the electronic device comprises:

one or more second processors 901 and a second memory 902. As an example, only one processor 901 is shown in FIG. 9.

The electronic device configured to perform the picture book recognition method further comprises a second input device 903 and a second output device 904.

The second processor 901, the second memory 902, the second input device 903, and the second output device 904 may be connected by a bus or other means. In FIG. 9, the bus connection is taken as an example.

The second memory 902 is a non-transitory computer-readable storage medium that may be used to store non-volatile software programs, non-volatile computer executable programs and modules, such as program instructions/modules corresponding to the picture book recognition method provided in the embodiments of the present invention, for example, the second receiving module 701, the recognizing module 702, the sending module 703 and the transmitting module 704 as shown in FIG. 7. The second processor 901 executes various functional applications and data processing of the server (namely, the picture book recognition method provided in the embodiments of the present invention) by running the non-volatile software program, instructions, and modules stored in the second memory 902.

The second memory 902 may include a program storage area and a data storage area, wherein the program storage area may store an operating system, and an application program required by at least one function, and the data storage area may store data created based on the use of the data recommendation device, and the like. In addition, the second memory 902 may include a high-speed random access memory and may further include a non-volatile memory such as at least one magnetic disk storage device, flash memory device, or other non-volatile solid-state storage device. In some embodiments, the second memory 902 optionally includes memories remotely located relative to the second processor 901, and these remote memories may be connected to a user behavior monitoring device through the network. Examples of the network include, but are not limited to, the Internet, an intranet, a local area network, a mobile communication network, and combinations thereof.

The second input device 903 may receive input digits or characters and generate a key signal input related to user setting and function control of the picture book recognition apparatus. The second output device 904 may include a display device such as a display screen.

The one or more modules are stored in the second memory 902 and, when executed by the one or more second processors 901, perform the picture book recognition method according to any of the above method embodiments. An embodiment of the electronic device that executes the picture book recognition method can produce the same or similar technical effects as the foregoing method embodiments.

Those ordinary skilled in the art should understand: the discussion on any of the above embodiments is merely exemplary, without intention to imply that the scope of the present disclosure (including the claims) is limited to those embodiments; consistent with the thought of the present disclosure, combinations of the technical features in one or more of the above embodiments are feasible, the steps may be performed in random order, and many other changes in different aspects of the present disclosure exist; for conciseness, these combinations and changes are not presented in details.

In addition, in order to simply explain and discuss as well as not to obscure the present disclosure, well-known power/grounding connection of integrated circuit (IC) chips and other components may be shown or may not be shown in the provided drawings. Moreover, the devices may be illustrated via block diagrams to avoid obscuring the present disclosure and moreover, real circumstances are also taken into account. That is, the details of the embodiments of these devices shown as the block diagrams are highly dependent on a platform for implementing the present disclosure, which indicates that these details should be totally in an understandable scope of those skilled in the art. Under the condition that the specific details (e.g., circuits) are elaborated to describe the exemplary embodiments of the present disclosure, it is apparent for those skilled in the art that the present disclosure may be implemented if there is no specific detail or the specific details have changed. Therefore, the descriptions should be considered as illustrative but not restrictive.

Although the present disclosure is described with specific embodiments, based on the forgoing descriptions, lots of alternatives, modifications and variations of the embodiments will be apparent for ordinary skilled in the art. For example, other memory architectures (e.g., a dynamic RAM (DRAM)) may be used in the discussed embodiments.

The embodiments of the present disclosure are intended to embrace all such alternatives, modifications and variations that fall within the wide range of the appended claims. Thus, any omission, modification, equivalent replacement, improvement and so on made within the spirit and principle of the present disclosure shall be encompassed by the protection scope of the present disclosure.

1. A picture book recognition method applied to an apparatus with a camera, comprising:
acquiring an image of the picture book with the camera at a preset acquisition frequency;
uploading the image to a server;
receiving a first audio link corresponding to the image returned from the server and, if the image is an image of a cover of the picture book, receiving a picture book ID corresponding to the cover image; and
connecting to a first audio stream in the server and playing the audio according to the first audio link.

2. The method according to claim 1, further comprising:
receiving a page turning instruction returned from the server;
acquiring a new image of the picture book with the camera at a preset acquisition frequency;
uploading the new image and the picture book ID to the server;
receiving a second audio link corresponding to the new image returned from the server; and
connecting to a second audio stream in the server and playing the audio according to the second audio link.

3. The method according to claim 1, further comprising:
receiving a start signal to give a prompt tone or a prompt message.

4. A picture book recognition method applied to an apparatus with a camera, comprising:
receiving an image of the picture book;
recognizing the image to obtain a recognition result and a score corresponding to the recognition result;
returning a first audio link corresponding to the recognition result having a score higher than a score threshold and, if the image is a cover image of the picture book, returning a picture book ID corresponding to the cover image; and
transmitting a first audio stream according to the first audio link.

5. The method according to claim 4, wherein recognizing the image comprises:
comparing the image with cover images of picture books stored in the database;
recognizing the image as the cover image if it matches any of the cover images stored in the database;
determining whether the image carries a picture book ID if it does not match any of the cover images stored in the database; and
if the image carries a picture book ID, determining a corresponding picture book according to the picture book ID, and comparing the image with inside page images of the corresponding picture book stored in the database.

6. The method according to claim 5, further comprising:
recognizing the image as an image of an inside page of the picture book if it matches any of the inside page images of the corresponding picture book stored in the database; and
recognizing the image as an image not included in the picture book, or an image of a cover of a new picture book if it does not match any of the inside page images of the corresponding picture book stored in the database.

7. The method according to claim 4, wherein the image is at least two images that are consecutively acquired;
recognizing the image to obtain a recognition result and a score corresponding to the recognition result comprises:
recognizing each of the images; and
if the recognition result of each image is the same, outputting the recognition result and the score corresponding to the recognition result.

8. The method according to claim 4, further comprising:
continuously receiving images;
recognizing the images to obtain the recognition result; and
determining that a page of the picture book is turned and returning a page turning instruction if the recognition result is different from the previous recognition result.

9. The method according to claim 8, further comprising:
receiving a new image and picture book ID thereof;
recognizing the new image to obtain a recognition result and a score corresponding to the recognition result;
returning a second audio link having a score higher than a score threshold; and
transmitting a second audio stream according to the second audio link.

10. A picture book recognition apparatus, comprising:
an acquiring module configured to acquire an image of the picture book at a preset acquisition frequency;
an uploading module configured to upload the image to a server;
a first receiving module configured to receive a first audio link corresponding to the image returned from the server and, if the image is an image of a cover of the picture book, receive a picture book ID corresponding to the cover image; and
a playing module configured to connect to a first audio stream in the server and playing the audio according to the first audio link.

11. The apparatus according to claim 10, wherein:
the acquiring module is further configured to acquire a new image of the picture book at a preset acquisition frequency;
the uploading module is further configured to upload the new image and the picture book ID to the server;
the first receiving module is configured to receive a page turning instruction returned from the server, and receive a second audio link corresponding to the new image returned from the server; and
the playing module is further configured to connect to a second audio stream in the server and playing the audio according to the second audio link.

12. The apparatus according to claim 10, further comprising:
a prompt module configured to receive a start signal to give a prompt tone or a prompt message.

13. A picture book recognition apparatus, comprising:
a second receiving module configured to receive an image of the picture book;
a recognizing module configured to recognize the image to obtain a recognition result and a score corresponding to the recognition result;
a sending module configured to return a first audio link corresponding to the recognition result having a score higher than a score threshold and, if the image is an image of a cover of the picture book, return a picture book ID corresponding to the cover image; and
a transmitting module configured to transmit a first audio stream according to the first audio link.

14. The apparatus according to claim 13, wherein the recognizing module is particularly configured to:
compare the image with cover images of picture books stored in the database;
recognize the image as a cover image if it matches any of the cover images of picture books stored in the database;
determine whether the image carries a picture book ID if it does not match any of the cover images of picture books stored in the database; and
if the image carries a picture book ID, determining a corresponding picture book according to the picture book ID, and comparing the image with inside page images of the corresponding picture book stored in the database.

15. The apparatus according to claim 14, wherein the recognizing module is particularly configured to:
recognize the image as an image of an inside page of the picture book if it matches any of the inside page images of the corresponding picture book stored in the database; and
recognize the image as an image not included in the picture book, or an image of a cover of a new picture book if it does not match any of the inside page images of the corresponding picture book stored in the database.

16. The apparatus according to claim 13, wherein the image is at least two images that are consecutively acquired;
the recognizing module is particularly configured to:
recognize each of the images; and
if the recognition result of each image is the same, output the recognition result and the score corresponding to the recognition result.

17. The apparatus according to claim 13, wherein:
the second receiving module is further configured to continuously receive images;
the recognizing module is configured to recognize the images to obtain the recognition result and determine that a page of the picture book is turned if the recognition result is different from the previous recognition result; and
the sending module is further configured to return a page turning instruction.

18. The apparatus according to claim 17, wherein:
the second receiving module is further configured to receive a new image and picture book ID thereof;
the recognizing module is further configured to recognize the new image to obtain a recognition result and a score corresponding to the recognition result;
the sending module is further configured to return a second audio link having a score higher than a score threshold; and
the transmitting module is further configured to transmit a second audio stream according to the second audio link.

19. A picture book recognition system comprising an apparatus according to claim 10 and an apparatus according to claim 13.

20. An electronic device comprising:
a camera for acquiring images;
at least one first processor; and
a first memory communicatively coupled to the at least one first processor;
wherein the first memory stores instructions executable by the at least one first processor, the instructions being executed by the at least one first processor to enable the at least one first processor to carry out the method according to claim 1.

21. An electronic device comprising:
at least one second processor; and
a second memory communicatively coupled to the at least one second processor;
wherein the second memory stores instructions executable by the at least one second processor, the instructions being executed by the at least one second processor to enable the at least one first processor to carry out the method according to claim 4.
